(19) United States
(12) Patent Application Publication
(10) Pub. No.: US 2021/0304257 A1
(43) Pub. Date: Sep. 30, 2021

(54) INFORMATION PROCESSING DEVICE, INFORMATION PROCESSING SYSTEM, AND INFORMATION PROCESSING METHOD

(71) Applicant: SHARP KABUSHIKI KAISHA, Osaka (JP)

(72) Inventor: TAKERU TSUCHIDA, Tokyo (JP)

(21) Appl. No.: 17/204,204

(22) Filed: Mar. 17, 2021

(30) Foreign Application Priority Data
Mar. 31, 2020 (JP) 2020-062146

(51) Int. Cl. G06Q 30/02; G06K 9/00; G09F 27/00

(52) U.S. Cl. CPC G06Q 30/0269; G06K 9/00275; G09F 9/33; G06K 2009/00322; G09F 27/005

(57) ABSTRACT

An information processing device includes a person determination unit and a content selection unit. The person determination unit is configured to determine, based on detection information acquired from a detection unit, an attribute of an approaching person who may have an interest in display content displayed on a display unit installed in association with the detection unit. The content selection unit is configured to refer to related content information indicating related content related to candidate content for each set of the candidate content and an attribute of a person, the candidate content being a candidate of the display content, and to select the related content related to the display content.

### CROSS-REFERENCE TO RELATED APPLICATION

The present application claims priority from Japanese Application JP2020-62146, the content of which is hereby incorporated by reference into this application.

### BACKGROUND OF THE INVENTION

### 1. Field of the Invention

The present disclosure relates to an information processing device, an information processing system, and an information processing method, and, for example, relates to an information processing device used for presenting related information related to advertisements.

### 2. Description of the Related Art

In a place through which a large number of unspecified people come and go, a signage device is sometimes installed for the purpose of providing various types of information guidance. Some known signage devices display eye-catching content for attracting customers, and display content for information guidance instead of the content for attracting customers when a user approaches the signage device. For example, the digital signage device described in JP 2016-177393 A captures an image in a first image quality mode and performs facial recognition on the captured image. Then, when movement of a person in front of the digital signage device satisfies a predetermined condition that can be considered as indicating an interest, the digital signage device captures an image in a second image quality mode having a higher image quality than that of the first image quality mode, and performs facial recognition on the captured image.

### SUMMARY OF THE INVENTION

However, the content for information guidance displayed on the known signage device does not necessarily provide information desired by an approaching person approaching the signage device. When the information provider doubts the benefit of providing information and refrains from providing the information, the approaching person may be even less likely to be provided with the desired information.

An aspect of the present disclosure has been conceived in light of the foregoing, and an object thereof is to provide an information processing device, an information processing system, and an information processing method that can provide information in which an approaching person has a greater interest.

An aspect of the present disclosure has been conceived to solve the problem described above, and the aspect of the present disclosure is an information processing device that includes a person determination unit configured to determine, based on detection information acquired from a detection unit, an attribute of an approaching person who may have an interest in display content displayed on a display unit installed in association with the detection unit, and a content selection unit configured to refer to related content information indicating related content related to candidate content for each set of the candidate content and an attribute of a person, the candidate content being a candidate of the display content, and to select the related content related to the display content.

Another aspect of the present disclosure is an information processing method for an information processing device, the information processing method including determining, based on detection information acquired from a detection unit, an attribute of an approaching person to display content displayed on a display unit installed in association with the detection unit, and referring to related content information indicating related content related to candidate content for each set of the candidate content and an attribute of a person, the candidate content being a candidate of the display content, and selecting the related content related to the display content.

According to the aspect of the present disclosure, it is possible to provide information in which a user has a greater interest.

### BRIEF DESCRIPTION OF THE DRAWINGS

FIG. 1 is a schematic block diagram illustrating an example of a functional configuration of an information processing system according to an embodiment.

FIG. 2 is a schematic block diagram illustrating an example of a hardware configuration of an information processing device according to the embodiment.

FIG. 3 is a diagram illustrating an example of advertisement management data according to the embodiment.

FIG. 4 is a diagram illustrating an example of response condition data according to the embodiment.

FIG. 5 is a diagram illustrating an example of related content management data according to the embodiment.

FIG. 6 is a sequence diagram illustrating an example of information provision processing according to the embodiment.

FIG. 7 is an explanatory diagram illustrating an example of an operation of the information processing system according to the embodiment.

FIG. 8 is a diagram illustrating an example of group attribute data according to the embodiment.

FIG. 9 is a diagram illustrating another example of the advertisement management data according to the embodiment.

FIG. 10 is a diagram illustrating another example of the response condition data according to the embodiment.

FIG. 11 is a diagram illustrating another example of the related content management data according to the embodiment.

FIG. 12 is a diagram illustrating yet another example of the response condition data according to the embodiment.

FIG. 13 is a diagram illustrating yet another example of the related content management data according to the embodiment.

### DETAILED DESCRIPTION OF THE INVENTION

An embodiment of the present disclosure will be described below with reference to the drawings.

### System Overview

First, an overview of an information processing system 1 according to the present embodiment will be described.

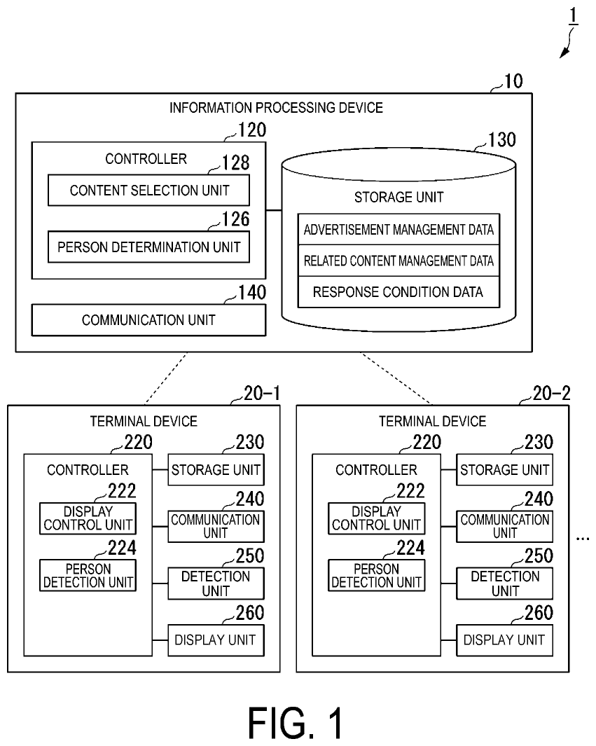

FIG. 1 is a schematic block diagram illustrating an example of a functional configuration of the information processing system 1 according to the present embodiment.

The information processing system 1 is configured to include an information processing device 10 and terminal devices 20. The information processing device 10 is connected to the terminal devices 20 in a wired or wireless manner such that various data can be transmitted and/or received to and from the terminal devices 20.

In the example illustrated in FIG. 1, the number of the terminal devices 20 is two, but may be one or three or more. The two terminal devices 20 are distinguished from each other using hyphenated numbers, which are 20-1 and 20-2. In the following description, unless otherwise indicated, it is assumed that the functional configurations of the plurality of terminal devices 20 are the same and that the plurality of terminal devices 20 operate independently of each other.

Based on detection information acquired from a detection unit 250 of the terminal device 20, the information processing device 10 determines an attribute of an approaching person who may have an interest in display content displayed on a display unit 260 installed in association with the detection unit 250, and selects related content related to the display content with reference to related content data indicating related content information. The detection unit 250 is installed in association with each of the individual terminal devices 20, and acquires the detection information used for detecting the approaching person and determining an attribute of the detected approaching person. The detection unit 250 is, for example, a camera that captures an image as the detection information.

The display content is configured, for example, as a guidance screen including information used for information provision, advertising, publicity, and the like targeting a large number of unspecified people. The related content is, for example, information related to the display content and is configured as a guidance screen including additional information intended to be provided for an approaching person having a specific attribute. The related content information is information indicating related content related to candidate content for each set of the candidate content and the attribute of the person, the candidate content being a candidate of the display content. The information processing device 10 outputs the related content data indicating the selected related content to the terminal device 20, which is a transmission source of the acquired detection information.

The information processing device 10 is, for example, a separate device from the terminal device 20, and is a server device used for controlling operations of the terminal device 20.

The terminal device 20 displays any one of the candidate contents as the display content, using the display unit 260. The number of the candidate contents is at least one, but is typically two or more. In that case, the terminal device 20 selects one of the two or more candidate contents as the display content on the basis of predetermined rules. The detection information is input to the terminal device 20 from the detection unit 250, and the terminal device 20 detects whether a person is approaching on the basis of the detection information. When approach of a person is detected, the terminal device 20 notifies the information processing device 10 of the detection information and identification information of the display content at that point in time. When the terminal device 20 receives the related content data from the information processing device 10, the terminal device 20 stops displaying the display content, and displays the related content on the basis of the related content data, using the display unit 260.

The terminal device 20 is, for example, a signage device. The terminal device 20 may be installed in a location that is passed by a large number of unspecified people and that can be easily spotted by those people, such as a railway station, an underground shopping center, a downtown area, or a public facility. In the following description, an example will be given in which the display content is primarily an advertisement.

### Information Processing Device

Next, an example of a functional configuration of the information processing device 10 according to the present embodiment will be described.

The information processing device 10 is configured to include a controller 120, a storage unit 130, and a communication unit 140.

The controller 120 controls various processing for causing the information processing device 10 to carry out the function and processing thereof. The controller 120 is configured to include a person determination unit 126 and a content selection unit 128.

Based on the detection information received from the terminal device 20, the person determination unit 126 determines, as an interested person, a person who is presumed to be showing an interest, namely, has an interest in the display content displayed on the display unit 260. As described later, the approaching person, who has come within a predetermined range from the display unit 260 of the terminal device 20, is a candidate of the interested person. An example of interested person determination processing for determining the interested person will be described below.

The person determination unit 126 determines an attribute of the detected interested person. The person determination unit 126 determines one or both of gender and age group as the attribute of the interested person by using, for example, existing image recognition processing on image data indicating an image of the head (face) of the interested person included in the detection information. The person determination unit 126 outputs attribute information indicating the determined attribute to the content selection unit 128.

The attribute information is input from the person determination unit 126 to the content selection unit 128, and the content selection unit 128 receives an advertisement ID (identifier) as an example of the identification information of the display content from the terminal device 20.

The content selection unit 128 refers to advertisement management data stored in advance in the storage unit 130, and identifies, as a target attribute, an attribute of a subject for whom an advertisement corresponding to the received advertisement ID is provided.

The advertisement management data is an example of the above-described candidate content data, and each individual advertisement corresponds to the candidate content. The content selection unit 128 determines whether the attribute indicated by the input attribute information (hereinafter referred to as an “input attribute”) is included in the identified target attribute. When the input attribute is included in the identified target attribute, the content selection unit 128 identifies a set of the identified advertisement ID and the input attribute as a response condition.

The content selection unit 128 refers to response condition data stored in advance in the storage unit 130, and identifies a related content ID corresponding to the response condition that forms a set of the received advertisement ID and input attribute.

Then, the content selection unit 128 refers to the related content management data stored in advance in the storage unit 130, and identifies the related content data indicating the related content corresponding to the identified related content ID. The content selection unit 128 transmits the identified related content data to the terminal device 20, which is the transmission source of the detection information. Information of the above-described related content is indicated by the response condition data and the related content management data, and the related content is associated with each of the sets of the advertisement ID and the target attribute. Note that examples of the advertisement management data, the response condition data, and the related content management data will be described later.

Note that when it is determined that the input attribute is not included in the identified target attribute, the content selection unit 128 may determine that there is no related content corresponding to the response condition that forms the set of the advertisement ID and the input attribute. In that case, the content selection unit 128 need not necessarily transmit new related content to the terminal device 20.

The storage unit 130 is configured to include a storage medium that stores various types of data. The storage unit 130 stores various types of data (including a parameter set) used in the processing executed by the controller 120, and various types of data acquired by the controller 120. The storage unit 130 stores, for example, the advertisement management data, the response condition data, and the related content management data, which will be all described later.

The communication unit 140 can be connected to other devices (including the terminal device 20) using a predetermined communication system in a wireless or wired manner. The communication unit 140 is configured to include a communication interface, for example. As the predetermined communication system, IEEE 802.11, 4th Generation Mobile Communication System (4G), 5th Generation Mobile Communication System (5G), and the like can be used, for example.

Note that the information processing device 10 may include an input/output unit (not illustrated) in place of the communication unit 140, or in conjunction with the communication unit 140. The input/output unit can be connected to other devices (including the terminal device 20) using a predetermined data input/output system in a wireless or wired manner. As the predetermined data input/output system, a High-Definition Multimedia Interface (HDMI) (trademark), a Serial Digital Interface (SDI), and the like can be used, for example.

Next, an example of a hardware configuration of the information processing device 10 according to the present embodiment will be described.

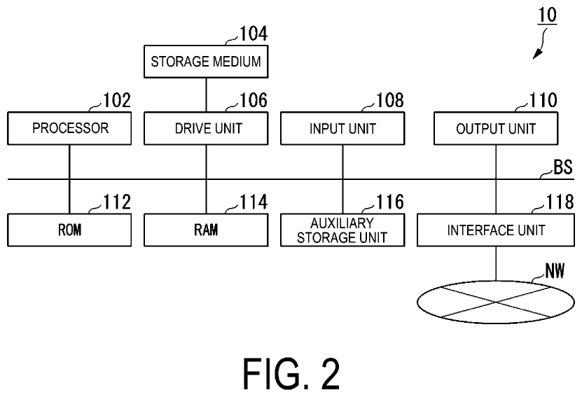

The information processing device 10 may be configured to include members that form each of the components illustrated in FIG. 1, but, as exemplified in FIG. 2, at least part of the information processing device 10 may be configured as a computer.

FIG. 2 is a schematic block diagram illustrating an example of the hardware configuration of the information processing device 10 according to the present embodiment.

The information processing device 10 is configured to include a processor 102, a drive unit 106, an input unit 108, an output unit 110, a Read Only Memory (ROM) 112, a Random Access Memory (RAM) 114, an auxiliary storage unit 116, and an interface unit 118.

The processor 102, the drive unit 106, the input unit 108, the output unit 110, the ROM 112, the RAM 114, the auxiliary storage unit 116, and the interface unit 118 are connected to one another using a bus BS.

The processor 102, for example, reads out programs and various types of data stored in the ROM 112 and executes the programs to control operations of the information processing device 10. The processor 102 is, for example, a Central Processing Unit (CPU).

The processor 102 may execute a predetermined program to implement a function of each of the functional units, such as the controller 120, for example. Note that, in the present application, execution of processing instructed by various commands written in the program may be referred to as “execution of a program” or “executing a program.”

The storage medium 104 stores various types of data. The storage medium 104 is a portable storage medium such as a magneto-optical disk, a flexible disk, or a flash memory.

The drive unit 106 is, for example, a device that performs one or both of reading out various types of data from the storage medium 104 and writing various types of data to the storage medium 104.

The input unit 108 is an input device that accepts a user operation, generates an operation signal in response to the accepted operation, and outputs the generated operation signal to the processor 102. The input unit 108 corresponds to a pointing device such as a mouse and a keyboard. In the present application, operating according to information indicated by an input operation signal may be simply referred to as “operating in response to an operation.”

The output unit 110 is configured to include a display unit such as a display, and a playback unit such as a speaker.

The ROM 112 stores, for example, programs to be executed by the processor 102.

The RAM 114 functions as a work area that temporarily stores various types of data and the programs used by the processor 102, for example.

The auxiliary storage unit 116 is a storage medium such as a Hard Disk Drive (HDD) or a flash memory. Note that the above-described storage unit 130 is configured by some or all of the ROM 112, the RAM 114, the auxiliary storage unit 116, and the storage medium 104 capable of storing various types of data and programs.

The interface unit 113 enables other devices to be connected and to input and output various types of data in a wired or wireless manner. The interface unit 118 includes a communication module that connects to a network NW in a wired or wireless manner and enables other devices connected to the network NW to transmit and receive various types of data to and from one another. The interface unit 118 corresponds to the above-described communication unit 140.

### Terminal Device

Next, an example of the functional configuration of the terminal device 20 according to the present embodiment will be described.

The terminal device 20 is configured to include a controller 220, a storage unit 230, a communication unit 240, the detection unit 250, and the display unit 260.

The controller 220 controls various processing for causing the terminal device 20 to carry out the function and processing thereof. The controller 220 is configured to include a display cortisol unit 222 and a person detection unit 224.

The display control unit 222 controls display of content on the display unit 260. The display control unit 222 selects at least one of a plurality of the preset candidate contents as the display content in accordance with predetermined rules. The display control unit 222 outputs, to the display unit 260, display content data indicating the selected display content. The display unit 260 displays the display content on the basis of the display content data input from the display control unit 222. As the predetermined rules, it is sufficient that a display time and a display order for one-time display of the candidate content be set in advance. It is sufficient that the display time for the one-time display be a time period sufficient for a person to notice the displayed candidate content and understand the information to be conveyed (e.g., five seconds to one minute). The display time may be constant regardless of the candidate content, or may be different depending on the individual candidate contents. The display order may be explicitly set for each of the candidate contents, or may be instructed by implicitly set information. As the implicitly set information, for example, a sequence order of the candidate content data (e.g., advertisement data) indicating the candidate content stored in the storage unit 230, or numbers configuring identification information (e.g., the advertisement ID) of the candidate content can be used. The display control unit 222 cyclically repeats processing of selecting the candidate content that is next in the display order when the display time of the chosen candidate content comes to an end. This operational mode may be referred to as a display content mode.

However, when person detection notification information indicating the detection of a person is input from the person detection unit 224, the display control unit 222 transmits, to the information processing device 10, the advertisement ID as an example of the identification information of the display content being displayed at that point in time. After transmitting the advertisement ID, the display control unit 222 determines whether to receive the related content data within a predetermined time (e.g., one to ten seconds). When the display control unit 222 receives the related content data, the display control unit 222 outputs the related content data to the display unit 260. The display unit 260 displays the related content data on is of the related content data input from the display control unit 222, and discontinues the display content mode. When the display control unit 222 does not receive the related content data, the display control unit 222 continues the display content mode with respect to the display unit 260.

Note that when person departure notification information indicating departure of the detected person is input from the person detection unit 224, the display control unit 222 resumes the discontinued display of the display content, and stops displaying the related content. When the display content mode is resumed, the display control unit 222 specifies, as the display content, the candidate content that is next in the display order following the display content being displayed during the discontinuation, for example. The display control unit 222 reads out the display content data indicating the specified display content from the storage unit 230, and outputs the read-out display content data to the display unit 260.

The person detection unit 224 determines whether a person present within a predetermined range from the display unit 260 is detected, based on the detection information input from the detection unit 250. The detection information includes, for example, image data indicating an image in a field of view of an area facing the display unit 260. The person detection unit 224 detects one person or two or more persons, for example, by performing existing image recognition processing on the image data. At this stage, because this is sufficient to determine the presence or absence of the person, image recognition processing as complex as that of the person determination unit 126 of the information processing device 10 is not required. Detection information other than an image may be input to the person detection unit 224, and the person detection unit 224 may detect the person on the basis of the input detection information.

The detection information more explicitly indicating the detection of the person may be input to the person detection unit 224, and the person detection unit 224 may determine the detection of the person on the basis of that detection information. The person detection unit 224 may determine the detection of the person, for example, when an operation signal acquired in response to an operation by the person is input from an input unit (not illustrated). Further, a motion sensor may be used as part of the detection unit 250. In that case, the person detection unit 224 may determine the detection of the person when the detection information indicating the detection of the person is input from the motion sensor. Any detection principle may be employed as the motion sensor, such as an infrared sensor or an ultrasonic sensor, as long as the detection principle is provided with the capability of detecting a person approaching the sensor.

When determining the detection of the person, the person detection unit 224 outputs at least part of the acquired detection information to the information processing device 10. It is sufficient that the detection information to be output includes information, such as image data, that helps to determine the interest of the person in the display content and the attribute of the person, for example. The person detection unit 224 outputs, to the display control unit 222, the person detection notification information indicating the detection of the person.

Note that when a state in which a person is detected changes to a state in which the person is not detected, the person detection unit 224 determines that the person has departed from the area within the predetermined range from the display unit 260, and outputs the person departure notification information to the display control unit 222. At this time, the person detection unit 224 stops transmitting the detection information to the information processing device 10.

The storage unit 230 is configured to include a storage medium that stores various types of data. The storage unit 230 stores various types of data used in the processing executed by the controller 220 and various types of data acquired by the controller 220. For example, the storage unit 230 stores the candidate content data in association with the identification information of the individual candidate contents.

The communication unit 240 can be connected to other devices (including the information processing device 10) using a predetermined communication system in a wireless or wired manner.

Note that the terminal device 20 may include an input/output unit (not illustrated) in place of the communication unit 240, or in conjunction with the communication unit 240 (independently from that of the information processing device 10). The input/output unit can be connected to other devices (including the information processing device 10) using a predetermined data input/output system in a wireless or wired manner.

The detection unit 250 is installed in association with the display unit 260, and detects a person in the predetermined range in front of the display unit 260 and information used for determining a degree of interest and the attribute of the person. The detection unit 250 outputs the detected detection information to the controller 220.

The detection unit 250 includes, for example, a camera. The camera functions as an image capturing, unit that captures an image including the predetermined range in front of the display unit 260 as the field of view. The detection unit 250 may include either a microphone, an input device, or a motion sensor, or a predetermined combination of these.

The microphone collects a voice coming from the predetermined range in front of the display unit 260, and functions as a sound collection unit that provides voice data indicating one collected voice as part of the detection information. The input device functions as an operation input unit that accepts an operation by the person and provides operation information indicating the accepted operation as part of the detection information. The motion sensor includes the predetermined range in front of the display unit 260 in a detection region, and provides, as part of the detection information, a person detection signal indicating whether the person in the detection region is detected. The detection principle employed in the motion sensor may be any system, such as an infrared ray system or an ultrasonic system.

The display unit 260 displays display information in a visually recognizable manner, based on various types of display data input from the controller 220. The above-described display content and related content can be the display information to be displayed. The display unit 260 is configured to include a display such as a Liquid Crystal Display (LCD) or an Organic Luminescence Display (OLED).

The terminal device 20 may have a hardware configuration similar to that exemplified in FIG. 2, and at least a portion thereof may be configured as a computer. In the terminal device 20, members corresponding to any one or any set of the drive unit 106 and the input unit 108 may be omitted. A processor of the terminal device 20 may execute a predetermined program to realize the function of the controller 220.

### Advertisement Management Data

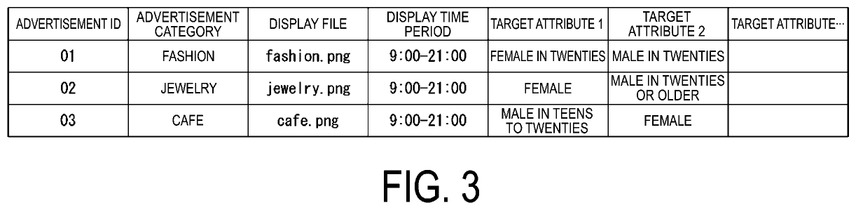

Next, an example of the advertisement management data according to the present embodiment will be described. FIG. 3 is a diagram illustrating an example of the advertisement management data according to the present embodiment.

The advertisement management data exemplified in FIG. 3 includes advertisement IDs, advertisement categories, display files, display time periods, and target attributes as elements, and is configured such that those elements are associated with each individual advertisement. The advertisement ID is identification information that identifies an individual advertisement. The advertisement category is the type of product or service that is advertised in the advertisement. The display file indicates a file name of a file that stores data indicating the advertisement. A display file field may be written with an address (e.g., a Uniform Resource Locator (URL)) that indicates the location of the display file. The display time period indicates a time period during which the advertisement is displayed. For an advertisement for which the display time period is not specified, the display time is not particularly limited. Instead of the display time period, or in conjunction with the display time period, a type of display day (a day of the week, a distinction between weekdays and holidays, and the like) may be specified. The target attribute indicates the attribute of the person to be targeted by the advertisement. Each of the advertisements may have one set of target attributes or a plurality of sets of target attributes. In the present embodiment, it is sufficient that each of the advertisement IDs includes at least one set of target attributes.

### Response Condition Data

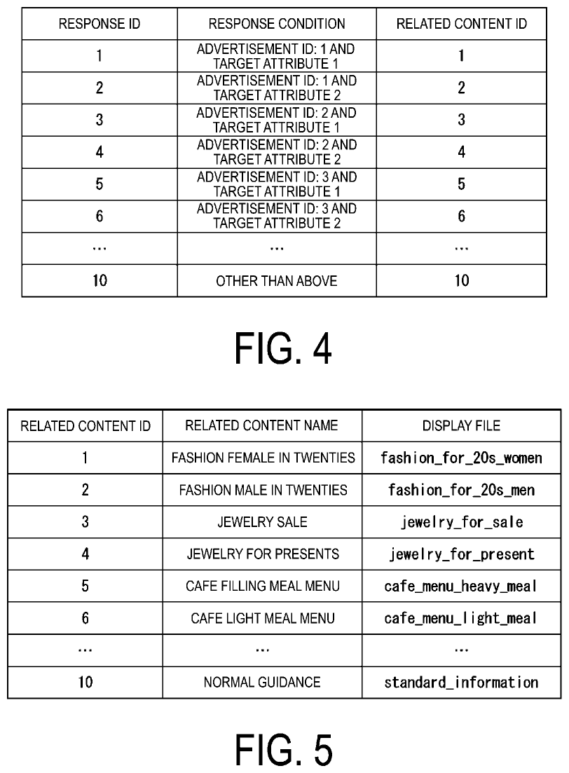

Next, an example of the response condition data according to the present embodiment will be described. FIG. 4 is a diagram illustrating an example of the response condition data according to the present embodiment.

The response condition data exemplified in FIG. 4 includes response IDs, response conditions, and related content IDs as elements, and is configured such that those elements are associated with each individual response condition. The response ID is identification information that identifies each individual response condition. The response condition indicates a set of the advertisement ID and the target attribute. The related content ID is identification information of the related content corresponding to the response condition. Note that when the response condition says “Other than above”, this indicates that none of the other response conditions listed are applicable. “Other than above” need not necessarily be defined. When “other than above” is not defined, the content selection unit 128 cannot select related content to be provided because there is no response condition data that matches the response condition, which is a set of the received advertisement ID and the input attribute. Thus, in the terminal device 20, the display content mode is continued.

### Related Content Management Data

Next, an example of the related content management data according to the present embodiment will be described. FIG. 5 is diagram illustrating an example of the related content management data according to the present embodiment.

The related content management data exemplified in FIG. 5 Includes related content IDs, related content names, and display files as elements, and is configured such that those elements are associated with each individual related content. The related content name indicates a name of the related content. The display file indicates a file name of a file that stores the related content data indicating the related content. The display file field may be written with an address that indicates the location of the related content data. In the related content data, the related content name may be omitted. Further, the related content data may be integrated with the response condition data and configured as related content data forming a single data structure. As a result of the integration, one of the related content ID fields, which is overlapping information, is omitted.

### Information Provision Processing

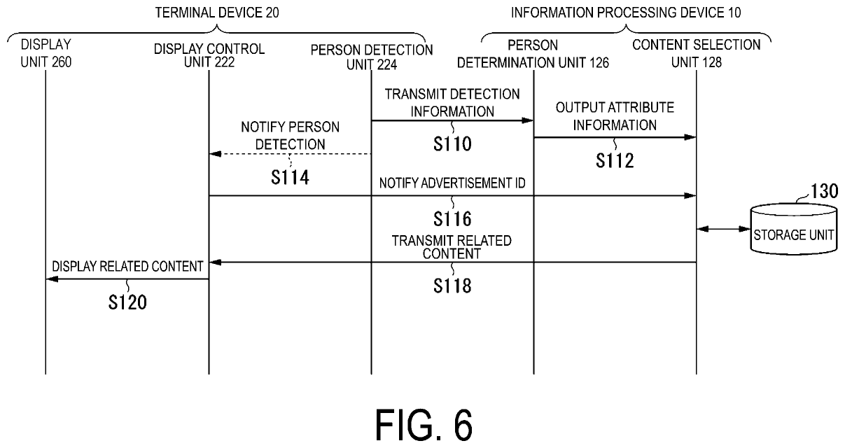

Next, information provision processing according to the present embodiment will be described. FIG. 6 is a sequence diagram illustrating an example of the information provision processing according to the present embodiment.

(Step S110) The person detection unit 224 of the terminal device 20 determines whether a person present within the predetermined range from the display unit 260 has been detected, on the basis of the detection information from the detection unit 250. When the person detection unit 224 determines the detection of the person, the person detection unit 224 transmits the acquired detection information to the information processing device 10.

(Step S112) The person determination unit 126 of the information processing device 10 detects an interested person that may have an interest in the display content, on the basis of the detection information received from the terminal device 20. The person determination unit 126 determines the attribute of the detected interested person, and outputs attribute information indicating the determined attribute to the content selection unit 128.

(Step S114) On the other hand, the person detection unit 224 outputs the person detection notification information to the display control unit 222 in response to the detection of the person.

(Step S116) The display control unit 222 transmits, to the information processing device 10, the advertisement ID of the advertisement that is being displayed on the display unit 260 at that point in time as the display content.

(Step S118) The content selection unit 128 of the information processing device 10 refers to the response condition data, and identifies the related content ID corresponding to the target attribute matching the set of the advertisement ID received from the terminal device 20 and the attribute indicated by the attribute information input from the person determination unit 126. The content selection unit 128 refers to the content management data to identify the file name of the related content corresponding to the identified related content ID, and reads out the related content data stored in the identified file from the storage unit 130. The content selection unit 128 transmits the read-out related content data to the terminal device 20.

(Step S120) The display control unit 222 of the terminal device 20 receives the related content data from the information processing device 10, and discontinues display of the display content. Then, the display control unit 222 outputs the received related content data to the display unit 260, and causes the display unit 260 to display the related content based on the related content data.

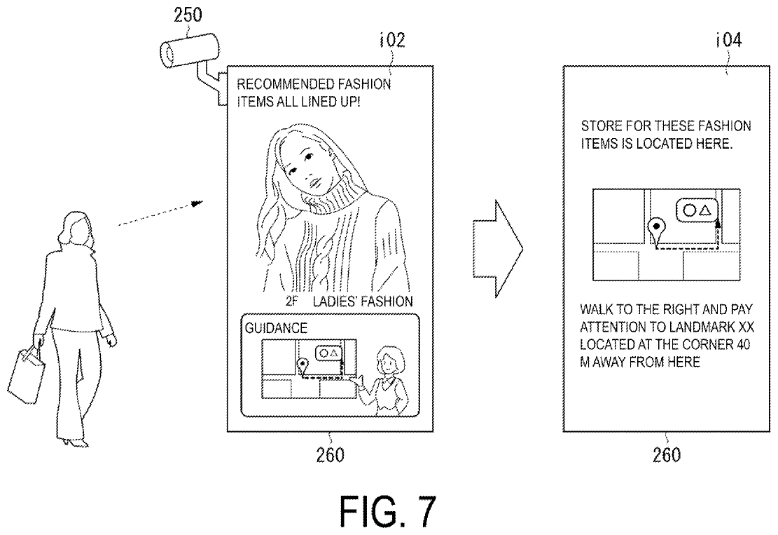

When the display unit 260 is displaying an image 102 of an advertisement as exemplified in FIG. 7, it is assumed that a visitor approaches the display unit 260 while viewing the image 102. According to the processing illustrated in FIG. 6, the person detection unit 224 detects the approach of the person. The person determination unit 126 determines that the approaching visitor is an interested person, and determines, as the attribute of the person, that the visitor is a female in her twenties, for example. An ID “01” is notified to the content selection unit 128 as the advertisement ID of the image 102, and the content selection unit 128 refers to the advertisement management data and determines the determined attribute to be “target attribute 1”. The content selection unit 128 refers to the response condition data and identifies the related content ID “1” corresponding to a set of the advertisement ID “1” and the “target attribute 1”. The content selection unit 128 refers to the related content management data and provides the terminal device 20 with related content data indicating a guidance screen 104 as the related content data corresponding to the related content ID “1”, which is stored in a display file “fashion_for_20s_women”and is designed to provide guidance with respect to a fashion store for women in their twenties. The display control unit 222 stops displaying the image 102 and starts displaying the guidance screen 104 based on the related content data provided from the content selection unit 128. As a result, the guidance screen 104 is provided as the related content corresponding to the attribute of a person who has shown an interest in the advertisement, which has been displayed as a screen for attracting customers.

### Interested Person Determination Processing

Next, an example or interested person determination processing will be described. The interested person determination processing may be performed by the person detection unit 224 of the terminal device 20 instead of the person determination unit 126 of the information processing device 10. When the person detection unit 224 determines that a detected approaching person is an interested person, the person detection unit 224 transmits the acquired detection information to the information processing device 10. It is sufficient that the person determination unit 126 of the information processing device 10 determines the attribute of the approaching person, who is the detected person, by using the detection information received from the terminal device 20, without performing the interested person determination processing. When the person detection unit 224 does not determine that the detected approaching person is an interested person, the person detection unit 224 need not necessarily transmit the acquired detection information to the information processing device 10. In the following description, a case in which the person determination unit 126 performs the interested person determination processing will be mainly described.

The interested person determination processing can be a technique using a captured image or a technique using operation information acquired in response to an operation by a user.

As an example of the technique using an image, the person determination unit 126 performs existing image recognition processing on the image data received from the terminal device 20, determines a face region in which the face appears, and determines the size of the face region. In the image recognition processing, features indicating characteristics of the face based on the captured image include a light and shade feature indicating a distribution of the color and brightness of the facial skin, and a shape feature indicating the size and shape of the outline of the face and relative arrangements between feature points of organs of the face (e.g., the outer corners of the eyes, the inner corners of the eyes, the nostrils, the top of the lip, the corners of the mouth, the eyebrows, and the like). The light and shade feature reflects “wrinkles”, “dullness”, “shininess”, and the like, which are conditions of the surface of the face. Thus, the light and shade feature may also be used to determine an attribute such as age and gender. The determination of the face region includes processing for detecting a region in which colors belonging to a predetermined range (a skin color or colors similar to the skin color in the color space) are spatially continuous, and determining, as the face region, a region which the detected shape feature points are distributed.

When a time period in which the size of the determined face region is a predetermined size or larger lasts for a predetermined duration (e.g., 3 to 15 seconds) or longer, the person determination unit 126 determines the person to be the interested person. According to this method, the approaching person, that is, the person who is present in the area within the predetermined range from the display unit 260 for the predetermined duration or longer is determined to be the interested person. The person determination unit 126 may use the features generated in the interested person determination processing that uses the image for determining the attribute of the interested person.

As another example of the technique using an image, the person determination unit 126 calculates a line-of-sight direction by using the shape feature obtained by performing existing image recognition processing on the image data. More specifically, the person determination unit 126 estimates directions of the pupils of each of the left and right eyes in the shape feature, based on relative positions between the centers of the pupils of each eye, the inner corner of each eye, and the outer corner of each eye and on an eyeball size that is set in advance. As the eyeball size, an average value of the radius of the human eyeball can be used. This is because it is generally known that the size of the eyeball does not vary much between people. The person determination unit 126 can determine closest points, at which two straight lines that are oriented in the line-of-sight directions of each of the eyes come closest to each other, and can determine directions extending from the centers of both of the eves toward the closest points on each of the straight lines as the line-of-sight directions. Then, the person determination unit 126 determines the person to be the interested person when the determined line-of-sight direction continues to be present, for the predetermined duration or longer, within a display region (that is, a region in which pixels are distributed) displaying an image on the display unit 260. According to this method, the approaching person, that is, the person who is viewing the display content displayed on the display unit 260 for the predetermined duration or longer is determined to be the interested person.

As an example of the technique using operation information, the person determination unit 126 determines a person who has been detected on the basis of other types of detection information (e.g., image data) to be the interested person when operation information indicating the start of presentation of the related content is acquired. Here, the terminal device 20 may include a dedicated button for indicating the start of the presentation of the related content, as an input unit. A character string such as “Start Guidance” may be affixed to the button itself or in the vicinity of the button as a label for indicating the presentation of the related content. Further, when a touch sensor that accepts operation is provided, as a mode of the input unit, in the detection region covering part or all of the display region of the display unit 260, an image of the button may be included in a partial region that forms a portion of the candidate content used as the display content. When operation information indicating the operation within the display region of the button is input, the person determination unit 126 may determine the detected person to be the interested person. Coordinates of the button in the display region are set in advance in the candidate content management data in association with the candidate content. Further, the label for indicating presentation of the related content is also affixed to that button.

Note that the candidate content used as the display content may include the image of the button in each of a plurality of the partial regions. Then, for each of the partial regions in which the button is displayed, information relating to the related content associated with the candidate content (specifically, the related content ID, the related content name, the display file, and the like) may be set in provision condition data and the related content management data. A label for indicating the display of the related content may be affixed to each of the individual buttons. The content selection unit 128 can identify the partial region (e.g., the display region of the button) on which an operation has been performed, based on the operation information included in the detection information received from the terminal device 20, and can select the related content corresponding to the identified partial region as the content to be provided.

In addition, when image data and voice data are included in the detection information received from the terminal device 20 and the location of the person has been determined from the image data, the person determination unit 126 may perform known voice activity detection (VAD) processing or voice recognition processing on the voice data. The person determination unit 126 may determine that the detected person is the interested person when the voice activity detection detects voice section in which speech is presumed to be included, or when the voice recognition processing detects speech (e.g., “Please tell me”) that indicates the presentation of the related content.

Note that when a plurality of types of the detection information is used, determination results regarding whether the person is the interested person may differ. In that case, priorities of the determination results may be set in advance for each type of the detection information, which has been acquired in a valid manner. For example, the person determination unit 126 prioritizes a determination result based on operation information acquired in response to an operation over determination results based on the other types of detection information. Since operation information based on an operation performed intentionally by the approaching person approaching the display unit 260 is used in preference to other types of objectively acquired detection information, the presence or absence of interest is more accurately determined.

Note that the number of persons detected on the basis of the detection information is not limited to one, and may be a plurality of persons. In that case, the plurality of persons having adjacent face regions within a predetermined distance are determined to be a group. The person determination unit 126 may determine, as a representative person, any one of the interested persons among the plurality of persons belonging to each of the groups, and may determine the attribute of the determined representative person. For example, the person determination unit 126 determines, as the representative person, one of the persons having the largest face size among the persons determined as the interested persons in the image. Alternatively, the person determination unit 126 may determine, as the representative person, a person who has been determined to be the interested person for the longest time period among the group of the plurality of detected people.

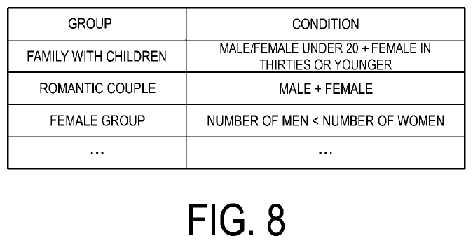

The person determination unit 126 may determine a groan attribute of the group consisting of the plurality of persons by using group attribute data indicating predetermined rules, based on a set of attributes of each of the plurality of interested persons belonging to each of the groups. Using the group attribute data exemplified in FIG. 8, when a set of attributes determined for each of the interested persons matches a condition that one or more of the interested persons is in their teens (either male or female) and one or both of a male in his thirties and a female in her thirties belong to the group, the person determination unit 126 determines the group attribute to be a family with children. Further, the person determination unit 126 determines an attribute of a group matching a condition that one man (any age) and one woman (any age) belong to the group to be a romantic couple. For example, the person determination unit 126 determines a group matching a condition that the number of women is larger than the number of men among the plurality of interested persons to be a group of women.

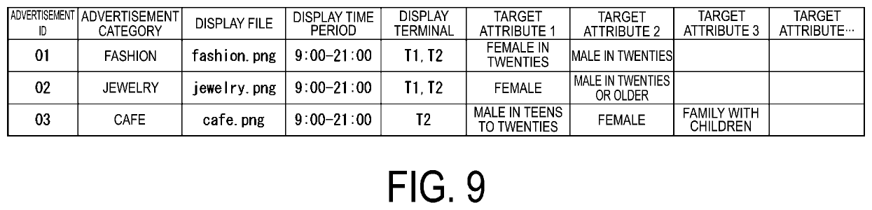

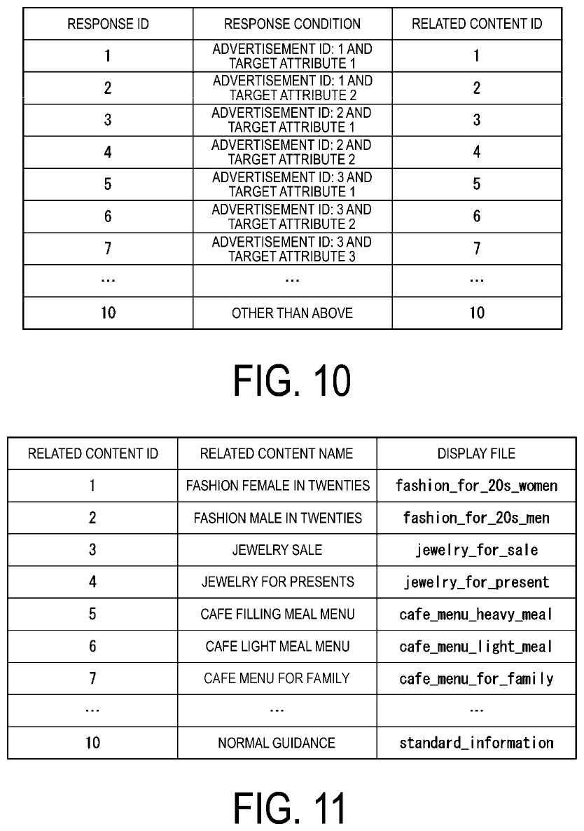

In the candidate content management data (the advertisement management data), the group attribute can also be set as the target attribute, which is the target of the candidate content. In the advertisement management data exemplified in FIG. 9, for an advertisement ID “3”, the group attribute “family with children” is set as a target attribute 3. In the response condition data, a set of the candidate content (the advertisement ID) and the group attribute, which serves as the target attribute, can be set as a response condition in association with the related content corresponding to the response condition. In the response condition data exemplified in FIG. 10, for the response ID “7”, a set of the advertisement ID “3” and the “target attribute 3” is set as a response condition in association with the related content ID “7”. In the related content management data, the related content can be set in association with the related content ID corresponding to each of the group attributes. In the related content management data exemplified in FIG. 11, the related content name “cafe menu for family” and the display file “cafe_menu_for_family” are set for the related content ID “7”.

By referring to the above-described candidate content management data, response condition data, and related content management data, the content selection unit 128 can identify the related content corresponding to the set of the candidate content displayed as the display content and the determined group attribute. For example, while the advertisement of the cafe identified by the advertisement ID “3” is being displayed, when a family with children continues to approach the display unit 260 for a predetermined time period or longer, the display unit 260 switches the screen to a menu guidance screen and displays the related content named as “cafe menu for family.” As a result, related content in which all members of the group may have an interest is provided.

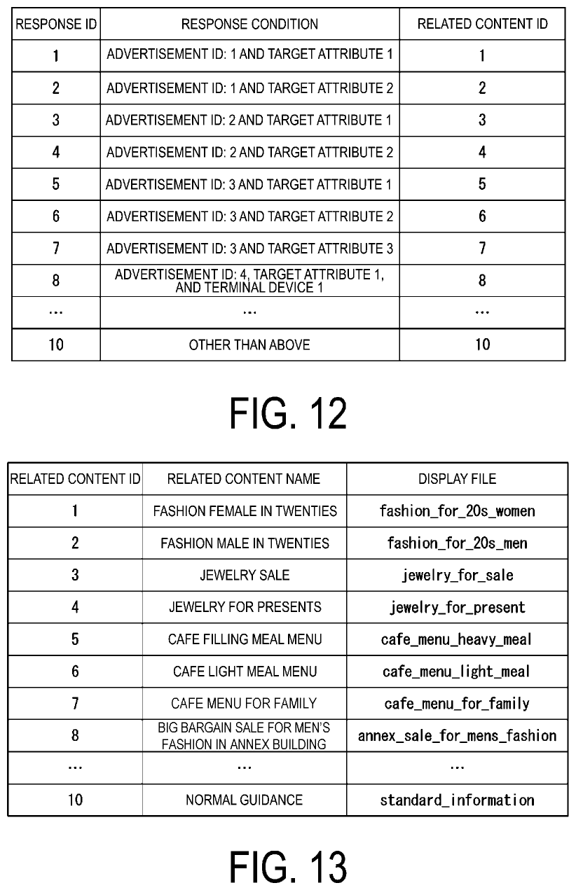

Note that, in the present embodiment, in addition to the candidate content and the attribute of the interested person, a display terminal of a display destination may be included as an element of the provision condition (the response condition) of the related content. Thus, in the response condition data, a set of the candidate content (the advertisement ID), the group attribute serving as the target attribute, and the display terminal can be set, as the response condition, in association with the related content corresponding to the response condition. In the response condition data exemplified in FIG. 12, for a response ID “8”, a set of the advertisement ID “4”, a “target attribute 1”, and a “terminal device 1” is set as the response condition in association with a related content ID “8”. In the related content management data, the related content can be set in association with each of the related content IDs. In the related content management data exemplified in FIG. 13, the related content name “big bargain sale for men's fashion in annex building” and the display file “annex_sale_for_mens_fashion” are set for the related content ID “8.”

By referring to the above-described candidate content management data, response condition data, and related content management data, the content selection unit 128 can identify the related content corresponding to a set of the candidate content displayed as the display content on the predetermined terminal device 20 and the determined attribute. For example, it is assumed that an advertisement on a bargain sale identified by an advertisement ID “4” is displayed on the display unit 260 of the terminal device 20-2, which is installed at an entrance of an annex building of a department store and is identified as the “terminal device 1.” In this case, when a male in his thirties identified by the “target attribute 1” continuously approaches the display unit 260 for the predetermined time period or longer, the display unit 260 switches the screen to a guidance screen for the bargain venue in the annex building, and displays the related content named “big bargain sale for men's fashion in annex building”. Thus, related content suitable for the installation location of the display unit 260 displaying the display content is provided.

As described above, the information processing device 10 according to the present embodiment includes the person determination unit 126 that determines, based on the detection information acquired from the detection unit 250, the attribute of the approaching person who may have an interest in the display content displayed on the display unit 260 installed in association with the detection unit 250. Further, the information processing device 10 includes the content selection unit 128 that refers to the related content information (e.g., the response condition data and the related content management data) indicating the related content related to the candidate content for each set of the candidate content and the attribute of the person, the candidate content being a candidate of the display content, and selects the related content related to the display content.

According to this configuration, the related content related to the display content and the attribute of the approaching person who may have an interest in the display content can be displayed in response to the detection of the approaching person who has approached the display unit 260. As a result, information in which the approaching person has a greater interest can be provided.

Further, the person determination unit 126 may determine a person appearing in the image configuring the detection information to be the approaching person who may have an interest in the display content, when the size of the person's face continues to be a predetermined size or larger for a predetermined duration or longer.

According to this configuration, a person continuously approaching the display unit 260 can be accurately estimated no be the approaching person who may have an interest in the display content displayed on the display unit 260.

Further, the person determination unit 126 may determine a person appearing in the image configuring the detection information to be the approaching person who may have an interest in the display content, when the line-of-sight direction of the person is a direction from the person toward the inside of the display region of the display unit 260.

According to this configuration, a person who is continuously viewing the display region of the display unit 260 can be accurately estimated to be the approaching person who may have an interest in the display content displayed on the display unit 260.

The person determination unit 126 may determine at least one of age group or gender as the attribute of the approaching person, based on the image acquired from the detection unit 250.

According to this configuration, it is possible to make the approaching person approaching the display unit 260 aware of presentation of the related content and to obtain information regarding the attribute of the approaching person without performing any special operation.

The person determination unit 126 may determine the group attribute of a group consisting of two or more persons appearing in the image acquired from the detection unit 250, based on attributes of the individual persons. The content selection unit 128 may refer, as the set of the candidate content and the attribute of the person, to the related content information (e.g., the group attribute data) including the sets of the candidate content and the group attribute to select the related content.

According to this configuration, it is possible to obtain information regarding the overall group attribute of the group consisting of two or more persons and to provide the candidate content in which the group having the group attribute may have an interest, as the display content.

When the operation information is acquired in response to an operation on the input unit of the terminal device 20, the person determination unit 126 may adopt the determination of the approaching person based on the operation information, in preference to the determination of the approaching person based on the image.

According to this configuration, by detecting the operation on the input unit based on the intention of the approaching person approaching the display unit 260, it is possible to accurately determine interest in the display content displayed on the display unit 260. Further, in a case in which a plurality of types of the detection information are acquired, even if differences arise in the determination of the presence or absence of the interest of the approaching person based on the individual types of the detection information, this configuration still contributes to accurate determination of the approaching person.

When detecting an operation (e.g., pressing down a button) on the predetermined partial region of the display content, the content selection unit 128 may select the related content corresponding to that partial region.

According to this configuration, it is possible to select the related content that can be provided in response to an operation on the input unit based on the intention of the approaching person approaching the display unit 260. Thus, it is possible to provide related content in which the approaching person, who may have an interest in the display content, has a greater interest.

The related content information may be configured to include identification information of the display unit 260 (e.g., the terminal device 20) that displays the candidate content in association with at least one of the candidate contents. The content selection unit 128 may select the related content corresponding to the identification information of the display unit 260 on which the display content has been displayed.

According to this configuration, different related contents are respectively provided for different display units 260 on which the display content is displayed. Thus, related content suitable for the installation location of the display unit 260 can be selectively presented.

An embodiment of the disclosure has been described in detail above with reference to the drawings, but the specific configuration is not limited to the embodiment described above, and various design modifications and the like can be made without departing from the gist of the present disclosure.

In the above description, an exemplary case is described in which the candidate content is an advertisement for specific goods or services, and the related content is guidance information regarding the location at which those goods or services are provided, but the present disclosure is not limited to this example. The candidate content may be another type of information, and it is sufficient that the candidate content be content including information intended to be disseminated to a large number of unspecified people, in particular. The candidate content may be information regarding various events (functions) such as special events, and information intended as announcements of public organizations including the government and local authorities. It is sufficient that the related content include related information different from the information included in the candidate content in accordance with an attribute, such as information that tends to attract interest from the person having that attribute, for example.

Further, the terminal device 20 may be configured to include a speaker that plays back a voice based on voice data input from the controller 220. When the display content or the related content includes a voice, the speaker may play back the voice.

In the terminal device 20, the detection unit 250 and the display unit 260 need not necessarily be configured integrally, as long as these components can be connected to other components such that various types of data can be input and output therebetween. The controller 220 of a single terminal device 20 may be connected not only to one set of the detection unit 250 and the display unit 260, but also to a plurality of sets of the detection unit 250 and the display unit 260 so as to be able to input and output various types of data between the controller 220 and each of the plurality of sets. In that case, the controller 220 may execute the above-described information provision processing, while treating each of the sets as a processing unit. In that case, the display unit 260 corresponding to the set, which is the processing unit, may be included as an element of a provision condition (in other words, the response condition) of the related content, instead of the display terminal.

In the information processing device 10, any one of the drive unit 106, the input unit 108, the output unit 110, and the auxiliary storage unit 116, or any set thereof may be omitted.

The information processing device 10 may be configured as a single device having the function of the terminal device 20. In that case, the communication unit 140 of the information processing device 10 and the communication unit 40 of the terminal device 20 may be omitted. Further, transmission and/or reception between the person detection unit 224 and the person determination unit 126, and transmission and/or reception between the display control unit 222, the person detection unit 224, and the content selection unit 128 are performed as input/output within the single device. In addition, by configuring the information processing device 10 as a single device, overlapping or unnecessary configurations and processing may be omitted.

Note that when the information processing device 10 or each of the individual terminal devices 20 is realized by a computer, a program for realizing the control function of the device may be recorded on a computer-readable recording medium, and the program recorded on the recording medium may be loaded into a computer system and executed, whereby the implementation is achieved.

Further, some or all of the information processing device 10 and the terminal devices 20 may be configured as integrated circuits such as Large Scale Integration (LSI). Each functional block of some of the information processing device 10 and the terminal devices 20 may be made into an individual processor, or some or all of the functional blocks may be integrated and made into a processor. Further, an integrated circuit technique is not limited to LSI, and each of the deices may be configured as a dedicated circuit or a general-purpose processor. In addition, in a case in which new technology for circuit integration emerges to replace LSI due to advancement in semiconductor technologies, an integrated circuit according to such new technology may be used.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing device comprising:
a person determination unit configured to determine, based on detection information acquired from a detection unit, an attribute of an approaching person who may have an interest in display content displayed on a display unit installed in association with the detection unit; and
a content selection unit configured to refer to related content information indicating related content related to candidate content for each set of the candidate content and an attribute of a person, the candidate content being a candidate of the display content, and to select the related content related to the display content.

2. The information processing device according to claim 1,
wherein the person determination unit determines that a person appearing in an image configuring the detection information is the approaching person in a case where a size of a face of the person is a predetermined size or larger for a predetermined duration or longer.

3. The information processing device according to claim 1,
wherein the person determination unit determines that a person appearing in an image configuring the detection information is the approaching person in a case where a line-of-sight direction of the person is a direct on toward an inside of a display region of the display unit.

4. The information processing device according to claim 2,
wherein the person determination unit determines, based on the image, at least one of an age group or a gender as the attribute of the approaching person.

5. The information processing device according to claim 2,
wherein the person determination unit determines a group attribute of a group consisting of no less than two persons appearing in the image, based on an attribute of each of the no less than two persons, and
the content selection unit refers to the related content information including a set of the candidate content and the group attribute as the set, and selects the related content.

6. The information processing device according to claim 2,
wherein, in a case where operation information is acquired in response to an operation on an input unit, the person determination unit prioritizes determination of the approaching person based on the operation information over determination of the approaching person based on the image.

7. The information processing device according to claim 6,
wherein, in a case where an operation on a predetermined partial region of the display content is detected, the content selection unit selects related content corresponding to the predetermined partial region.

8. The information processing device according to claim 1,
wherein the related content information includes identification information of the display unit on which the candidate content is displayed, in association with the candidate content, and
the content selection unit selects related content corresponding to identification information of the display unit on which the display content is displayed.

9. An information processing system, comprising:
the detection unit;
the display unit; and
the information processing device according to claim 1.

10. An information processing method for an information processing device, the information processing method comprising:
determining, based on detection information acquired from a detection unit, an attribute of an approaching person to display content displayed on a display unit installed in association with the detection unit; and
referring to related content information indicating related content related to candidate content for each set of the candidate content and an attribute of a person, the candidate content being a candidate of the display content, and selecting the related content related to the display content.
